(19) United States
(12) Patent Application Publication
(10) Pub. No.: US 2024/0201911 A1
(43) Pub. Date: Jun. 20, 2024

(54) IMAGE PROCESSING SYSTEM, IMAGE PROCESSING APPARATUS, TERMINAL APPARATUS, AND PROGRAM

(71) Applicant: KYOCERA CORPORATION, Kyoto-shi (JP)

(72) Inventors: Hiroshi OKA, Kyoto-shi (JP); Shingo ITO, Kyoto-shi (JP); Shigeki TAKAYA, Yokohama-shi (JP); Daisuke HARA, Kirishima-shi (JP)

(21) Appl. No.: 18/590,854

(22) Filed: Feb. 28, 2024

Related U.S. Application Data
(63) Continuation of application No. PCT/JP2022/037178, filed on Oct. 4, 2022.

(51) Int. Cl. G06F 3/12; G06K 7/10; G06K 7/14; G06K 19/06; H04N 1/32

(52) U.S. Cl. CPC G06F 3/121; G06F 3/1234; G06F 3/1236; G06F 3/1286; G06F 3/1292; G06K 7/10722; G06K 7/1417; G06K 19/06037; H04N 1/32122; H04N 2201/3269; H04N 2201/3273

(57) ABSTRACT

An image processing apparatus for performing image processing including printing and/or scanning includes: a first display including a window for displaying a code; and a first controller that causes the first display to display, based on occurrence of an error in the image processing apparatus, the code obtained by encoding text describing information related to content of the error in a natural language and/or an error identifier associated with the text. The terminal apparatus includes: a second display; an imager that images the code displayed on the first display; and a second controller that acquires the text based on the code imaged by the imager without acquiring the text via the Internet and causes the second display to display error information including the acquired text.

### RELATED APPLICATIONS

The present application claims priority to PCT Application No. PCT/JP2022/037178 (filed on Oct. 4, 2022), the contents of which are incorporated herein by reference in their entirety.

### TECHNICAL FIELD

The present disclosure relates to an image processing system, an image processing apparatus, a terminal apparatus, and a program.

### BACKGROUND OF INVENTION

An image processing apparatus such as a printer includes a display that displays an image including various types of information. Such a display of an image processing apparatus is generally smaller in size and has a lower resolution than a display of a terminal apparatus such as a smartphone or a tablet terminal. Therefore, when an error occurs in the image processing apparatus, error information such as a countermeasure method against the error is difficult to display on the display of the image processing apparatus.

Patent Documents 1 and 2 disclose a method for displaying a two-dimensional code obtained by encoding a Uniform Resource Locator (URL) for accessing a web site provided by a server on a display of an image processing apparatus when an error occurs in the image processing apparatus and a predetermined key of the image processing apparatus is pressed. As the two-dimensional code, a QR code (trade name) is used. A terminal apparatus with a camera accesses a web server by imaging the two-dimensional code, and displays a manual of the image processing apparatus on the display of the terminal apparatus.

Note that the URL is a character string for specifying a resource on the Internet. Unlike natural languages that are easily readable by humans (e.g., Japanese or English), URLs are described in non-readable or difficult to read formal languages.

### CITATION LIST

### Patent Literature

Patent Document 1: JP 2021-9467 A
Patent Document 2: JP 2021-22123 A

### SUMMARY

According to a first aspect, an image processing system includes a terminal apparatus, and an image processing apparatus that performs image processing including printing and/or scanning. The image processing apparatus includes: a first display including a window for displaying a code; and a first controller that causes the first display to display, based on occurrence of an error in the image processing apparatus, the code obtained by encoding text describing information related to content of the error in a natural language and/or an error identifier associated with the text. The terminal apparatus includes: a second display, an imager that images the code displayed on the first display; and a second controller that acquires the text based on the code imaged by the imager without acquiring the text via the Internet and causes the second display to display error information including the acquired text.

According to a second aspect, the image processing apparatus performs image processing including printing and/or scanning. The image processing apparatus includes: a display including a window for displaying a code; and a controller that causes the display to display, based on occurrence of an error in the image processing apparatus, the code obtained by encoding text describing information related to content of the error in a natural language and/or an error identifier associated with the text.

According to a third aspect, a terminal apparatus includes: a display, an imager that images a code displayed on a window in an image processing apparatus for performing image processing including printing and/or scanning; and a controller that acquires text describing information related to content of an error having occurred in the image processing apparatus in a natural language, based on the imaged code without acquiring the text via the Internet, and causes the display to display error information including the acquired text.

According to a fourth aspect, a program causes a terminal apparatus including an imager and a display to execute: imaging a code displayed on a window in an image processing apparatus for performing image processing including printing and/or scanning; acquiring text describing information related to content of an error having occurred in the image processing apparatus in a natural language, based on the imaged code without acquiring the text via the Internet; and causing the display to display error information including the acquired text.

### BRIEF DESCRIPTION OF THE DRAWINGS

FIG. 1 is a diagram illustrating a configuration example of an image processing system according to first to fourth embodiments.

FIG. 2 is a diagram illustrating a configuration example of an image processing apparatus according to the first to fourth embodiments.

FIG. 3 is a diagram illustrating a configuration example of a terminal apparatus according to the first to fourth embodiments.

FIG. 4 is a diagram illustrating an operation example when an error occurs in the image processing system according to the first embodiment.

FIG. 5 is a diagram illustrating an operation example when an error is resolved in the image processing system according to the first to fourth embodiments.

FIG. 6 is a diagram illustrating an outline of an operation of the image processing system according to the second embodiment.

FIG. 7 is a diagram illustrating an operation example when an error occurs in the image processing system according to the second embodiment.

FIG. 8 is a diagram illustrating an outline of an operation of the image processing system according to the third embodiment.

FIG. 9 is a diagram illustrating an operation example when an error occurs in the image processing system according to the third embodiment.

FIG. 10 is a diagram illustrating an operation example of the image processing apparatus according to the fourth embodiment.

### DESCRIPTION OF EMBODIMENTS

Embodiments are described with reference to the drawings. In the description of the drawings, the same or similar parts are denoted by the same or similar reference signs.

### (1) Overview of Embodiments

A known method for accessing a web server by imaging, with a terminal apparatus, a two-dimensional code displayed on an image forming apparatus has room for improvement in terms of further improving user convenience. For example, in the known method, when the terminal apparatus does not have an Internet connection and/or when a server failure occurs, the terminal apparatus cannot access the web server and the user cannot view error information such as a manual.

According to the present disclosure, an image processing system can further improve user convenience. According to the present disclosure, an image processing system includes a terminal apparatus, and an image processing apparatus configured to perform image processing including printing and/or scanning. The image processing apparatus includes: a first display including a window for displaying a code; and a first controller that causes the first display to display, based on occurrence of an error in the image processing apparatus, the code obtained by encoding text describing information related to content of the error in a natural language and/or an error identifier associated with the text. The terminal apparatus includes: a second display, an imager that images the code displayed on the first display, and a second controller that acquires the text based on the code imaged by the imager without acquiring the text via the Internet and causes the second display to display error information including the acquired text.

### (2) First Embodiment

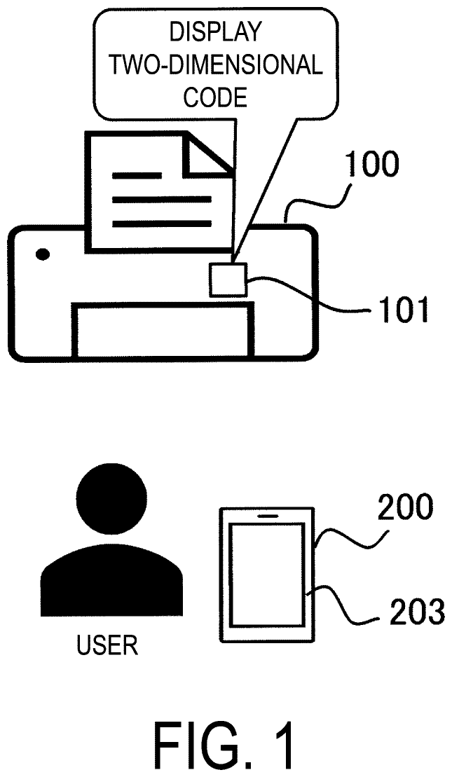

First, a first embodiment is described with reference to FIGS. 1 to 5.

### (2.1) Configuration Example of System

FIG. 1 is a diagram illustrating a configuration example of an image processing system according to the present embodiment. The image processing system includes an image processing apparatus 100 and a terminal apparatus 200.

The image processing apparatus 100 is an apparatus that performs image processing including printing and/or scanning. The image processing apparatus 100 may be a printer, a copier, a scanner, a facsimile machine, or a multifunction printer having these functions. The image processing apparatus 100 includes a display 101 that displays an image.

The terminal apparatus 200 is a terminal with a camera function. The terminal apparatus 200 may be a mobile terminal having a wireless communication function, such as a smart phone, a tablet terminal, or a notebook computer (PC). The terminal apparatus 200 is not limited to such a general-purpose terminal and may be a dedicated terminal for performing the operation according to the present embodiment. Such a dedicated terminal may not have wireless communication function.

The display 101 of the image processing apparatus 100 is lower in resolution, lower in refresh rate, and/or smaller in size than a display 203 of the terminal apparatus 200. In the present embodiment, the image processing apparatus 100 includes the display 101 that is as small as possible to display a two-dimensional code. The two-dimensional code is, for example, a QR code (trade name). The display 101 of the image processing apparatus 100 includes a substantially square window along an outer peripheral shape of the two-dimensional code. The present embodiment mainly describes an example in which the code displayed by the image processing apparatus 100 (display 101) is a two-dimensional code. However, the code displayed by the image processing apparatus 100 (display 101) may be a one-dimensional code (for example, a barcode).

The terminal apparatus 200 may execute an operation application used for operating the image processing apparatus 100. The terminal apparatus 200 that executes the operation application causes the display 203 to display thereon an operation screen of the image processing apparatus 100. The operation screen includes a connection screen used when connecting to the image processing apparatus 100, and a menu screen used after connecting to the image processing apparatus 100. On the menu screen, an operation button for instructing to perform image processing may be displayed for each type of image processing.

The terminal apparatus 200 may operate the image processing apparatus 100 through wireless communication with the image processing apparatus 100. For example, the terminal apparatus 200 establishes a direct wireless communication connection with the image processing apparatus 100 to perform direct wireless communication with the image processing apparatus 100. Such direct wireless communication may be an ad hoc mode (also referred to as an “access point mode”) of a wireless local area network (LAN) communication scheme. In this case, the image processing apparatus 100 functions as a wireless LAN access point. The wireless LAN communication scheme may be a scheme conforming to the IEEE 802.11 standards. Alternatively, the direct wireless communication may be wireless communication of a Bluetooth (trade name) scheme. Hereinafter, an example is mainly described in which the ad hoc mode of the wireless LAN communication scheme is used for the direct wireless communication between the image processing apparatus 100 and the terminal apparatus 200.

### (2.2) Configuration Example of Image Processing Apparatus

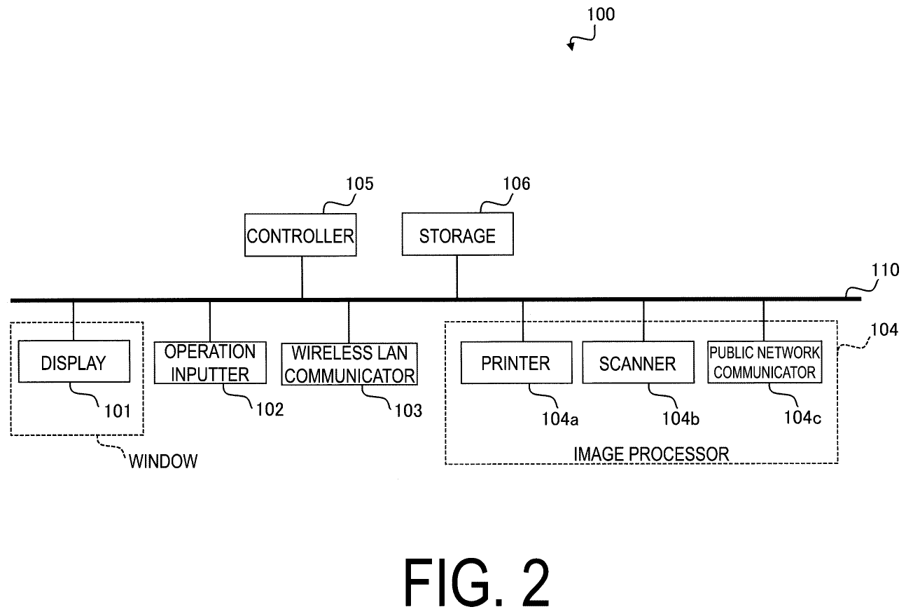

FIG. 2 is a diagram illustrating a configuration example of the image processing apparatus 100 according to the present embodiment.

The image processing apparatus 100 includes the display 101, an operation inputter 102, a wireless LAN communicator 103, an image processor 104, a controller 105, and a storage 106. The display 101, the operation inputter 102, the wireless LAN communicator 103, the image processor 104, the controller 105, and the storage 106 are electrically connected to each other through a bus 110, for example. In the illustrated example, all the components are schematically connected to one bus 110, but a plurality of buses, for example, an address bus, a data bus, and a control bus may be provided. An interface may be interposed between the bus 110 and each component. Note that at least a portion of the operation inputter 102 that receives a user operation (user input) may be integrated with the display 101 that displays an image to configure a touch panel display.

The display 101 includes a liquid crystal display or an organic electro luminescence (EL) display. These displays include a relatively large number of pixels regularly arranged, and can display an image including an arbitrary shape based on image data. The display 101 may be capable of displaying a color image, may be capable of displaying only a grayscale image (and a monochrome image), or may be capable of displaying only a monochrome image (a binary image). In the present embodiment, the display 101 include a window for displaying a two-dimensional code. The window (display 101) has a substantially square shape along the outer peripheral shape of the two-dimensional code.

The operation inputter 102 includes one or more physical buttons (physical keys) and/or a touch panel in the touch panel display. The touch panel may be electrostatic or pressure-sensitive. The touch panel overlapping with the display 101 detects a position of a touch operation on the display 101 and outputs a detection result. The operation inputter 102 may include a button for displaying a two-dimensional code. The button may be a physical button (physical key) or a button (soft key) displayed by the display 101. When the button is pressed, the controller 105 may cause the display 101 to display thereon a two-dimensional code obtained by encoding information related to a current status. For example, when an error occurs in the image processing apparatus 100, the controller 105 provides notification of the occurrence of the error by blinking the button or blinking a LED. When the user operates the button in such a state, the controller 105 may cause the display 101 to display thereon a two-dimensional code obtained by encoding information related to the error.

The wireless LAN communicator 103 performs wireless communication of the wireless LAN communication scheme. The wireless LAN communicator 103 may perform direct wireless communication with the terminal apparatus 200 in the ad hoc mode of the wireless LAN communication scheme. Such direct wireless communication is also referred to as WiFi (trade name) direct. The wireless LAN communicator 103 may be considered to include only a hardware configuration (for example, a connector, an antenna, an amplifier, a filter, and a radio frequency (RF) circuit), or may be considered to include a software configuration in addition to the hardware configuration. Note that a Bluetooth (trade name) communicator that performs direct wireless communication with the terminal apparatus 200 may be provided instead of or in addition to the wireless LAN communicator 103.

The image processor 104 performs the image processing including printing and/or scanning. For example, the types of image processing include “print”, “copy”, “scan”, and “FAX (facsimile)”. The type “copy” refers to a function in which a printer 104a prints image data, which is acquired by a scanner 104b scanning a document, on a paper sheet. The type “print” refers to function in which the printer 104a prints an image based on image data received by the wireless LAN communicator 103 from the image processing apparatus 200 or image based on data stored in a recording media (not illustrated) connected to the image processing apparatus 100. The type “scan” refers to a function of storing image data acquired by the scanner 104b scanning a document. A storage destination may be, for example, an auxiliary storage device (a nonvolatile memory from another viewpoint) included in the storage 106 or a storage medium connected to the image processing apparatus 100. The type “FAX” refers to a function in which the printer 104a prints image data, which is received by a public network communicator 104c from outside via a telephone line, on a paper sheet, and a function in which the public network communicator 104c externally transmits image data, which is acquired by the scanner 104b scanning a document, to outside via the telephone line. Note that the “image” may include only characters. A format of the “image data” may be various, and may be, for example, a vector format or a raster format. In the description of the present embodiment, “image” and “image data” may not be strictly distinguished from each other for the sake of convenience. The “image data” may be converted into an appropriate format in the course of the image processing. For example, the image data stored in the image processing apparatus 100 may be different from data when the image processing is performed (for example, printing or FAX).

The printer 104a performs printing under the control of the controller 105. For example, the printer 104a performs printing on a paper sheet set in a sheet feed tray and discharges the printed sheet to a sheet discharge tray. The printer 104a may include only one sheet feed tray or may include a plurality of sheet feed trays. From another viewpoint, the printer 104a may have a function of selecting a size of a paper sheet. The printer 104a may be configured to be capable of color (and monochrome and gray scale) printing, may be configured to be capable of only grayscale (and monochrome) printing, or may be configured to be capable of only monochrome printing. For example, the printer 104a may be an inkjet printer that performs printing by ejecting ink, a thermal printer that performs printing by heating a heat-sensitive paper or an ink ribbon, or an electrophotographic printer (for example, a laser printer) that transfers toner attached to a photoreceptor irradiated with light. For example, the printer 104a may be a line printer in which its head has a length across a width of the paper sheet (in a direction intersecting a conveyance direction of the paper sheet), or may be a serial printer in which its head moves in a width direction of the paper sheet.

The scanner 104b performs scanning under the control of the controller 105. The scanner 104b images (scans) a document set on a document table or an auto document feeder (ADF) by an imaging device that moves along a document glass to generate image data.

The public network communicator 104c performs image data communication via a public network under the control of the controller 105. The public network includes a telephone network and/or the Internet. The public network communicator 104c may communicate with a file server, an e-mail server, and/or a web server. The communication may be a wired communication or may include a wireless communication.

The controller 105, which includes one or more processors, controls the entire image processing apparatus 100. For example, the controller 105 executes programs stored in the storage 106 to perform various type of processing. In the present embodiment, the controller 105 controls the display 101, the operation inputter 102, the wireless LAN communicator 103, the image processor 104, and the storage 106. Note that the controller 105 may include a logic circuit or the like configured to perform only a certain operation. The operations of the image processing apparatus 100 described above and below may also be operations controlled by the controller 105.

The storage 106 includes various memories such as a read only memory (ROM), a random access memory (RAM), and an auxiliary storage device, for example. Note that a combination of the controller 105 and the storage 106 may be considered as a computer. The program executed by the controller 105 is stored in, for example, the ROM and/or the auxiliary storage device of the storage 106.

Note that FIG. 2 is merely a schematic view. For example, a plurality of controllers 105 and storages 106 may be provided in a distributed manner. For example, a processor included in each component (a controller that controls each component from another viewpoint) and a higher layer processor (a higher layer controller that controls the controller of each component) may be provided. In such a case, the controller 105 may be considered as the higher layer controller, or may be considered as a combination of the controller of each component and the higher layer controller.

In the image processing apparatus 100 configured as described above, the storage 106 stores in advance text (also referred to as an “error text”) describing information related to content of an error in a natural language for each content of the error. The storage 106 may store in advance a two-dimensional code obtained by encoding the error text.

The error text includes content information indicating the content of the error and/or countermeasure information indicating a countermeasure method against the error.

For example, the content information indicating the content of the error may be information (text) “Ink runs low on”. In this case, the countermeasure information indicating the countermeasure method against the error may be information (text) “Printing is possible until the message of ink cartridge replacement is displayed, but printing is not possible when even one color of ink reaches the limit value. Please prepare a new ink cartridge early.”

As another example, the content information indicating the content of the error may be information (text) “Paper sheet is jammed on the back side of the printer”. In this case, the countermeasure information indicating the countermeasure method against the error may be information (text) “Please remove the paper sheet and press the reset button to cancel the error. The power may need to be turned on again.”

Furthermore, the storage 106 may store in advance text (also referred to as an “error resolution text”) describing resolution information displayed when the error is resolved in a natural language for each content of the error. The storage 106 may store in advance a two-dimensional code obtained by encoding the error resolution text.

The controller 105 detects an error having occurred in the image processing apparatus 100. Based on occurrence of the error in the image processing apparatus 100, the controller 105 acquires an error text corresponding to content of the error from the storage 106, generates a two-dimensional code by encoding the acquired error text, and displays the generated two-dimensional code on the display 101. Alternatively, when the storage 106 stores in advance the two-dimensional code for each error, the controller 105 acquires the two-dimensional code corresponding to the content of the error from the storage 106, based on occurrence of the error in the image processing apparatus 100, and displays the acquired two-dimensional code on the display 101.

### (2.3) Configuration Example of Terminal Apparatus

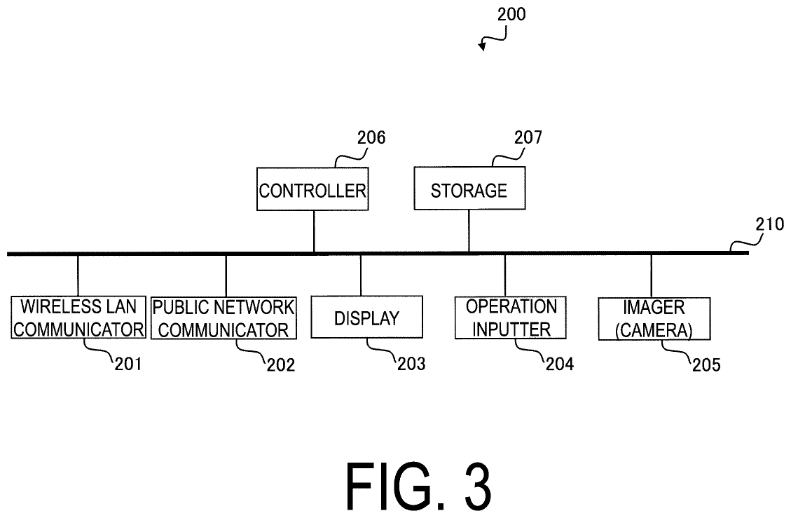

FIG. 3 is a diagram illustrating a configuration example of the terminal apparatus 200 according to the present embodiment. Here, a description of a configuration the same as and/or similar to the above-described configuration is omitted as appropriate.

The terminal apparatus 200 includes a wireless LAN communicator 201, a public network communicator 202, the display 203, an operation inputter 204, an imager 205, a controller 206, and a storage 207. The wireless LAN communicator 201, the public network communicator 202, the display 203, the operation inputter 204, the imager 205, the controller 206, and the storage 207 are electrically connected to each other through a bus 210, for example.

The wireless LAN communicator 201 performs wireless communication of the wireless LAN communication scheme. The wireless LAN communicator 201 may perform direct wireless communication with the image processing apparatus 100 in the ad hoc mode of the wireless LAN communication scheme. A Bluetooth (trade name) communicator that performs direct wireless communication with one or more terminal apparatuses 200 may be provided instead of or in addition to the wireless LAN communicator 201.

The public network communicator 202 performs communication via a public network. The public network may include the Internet and/or a cellular network. The public network communicator 202 may be a cellular communicator that performs cellular communication.

The display 203 displays an image under control of the controller 206. The operation inputter 204 receives a user operation (user input). At least a portion of the operation inputter 204 may be integrated with the display 203 to configure a touch panel display. At least a portion of the operation inputter 204 may be configured as one or more physical buttons. The display 203 includes a liquid crystal display or an organic EL display. The operation inputter 204 detects a position of a touch operation on the display 203 and outputs a detection result.

The imager 205 includes a camera including an imaging sensor such as a charge coupled device (CCD) or a complementary metal oxide semiconductor (CMOS). The imager 205 electrically images an image and outputs image data under the control of the controller 206. The controller 206, which includes one or more processors, controls the entire terminal apparatus 200. The controller 206 executes programs stored in the storage 207 to perform various type of processing. The program may include an operation application for operating the image processing apparatus 100. The controller 206 controls an operation of each of the wireless LAN communicator 201, the public network communicator 202, the display 203, the operation inputter 204, the imager 205, the controller 206, and the storage 207. Note that the controller 206 may include a logic circuit or the like configured to perform only a certain operation. The operations of the terminal apparatus 200 described above and below may also be operations controlled by the controller 206.

The storage 207 includes various memories such as a ROM, a RAM, and an auxiliary storage device, for example. A combination of the controller 206 and the storage 207 may be considered as a computer. The program executed by the controller 206 is stored in, for example, the ROM and/or the auxiliary storage device of the storage 207.

In the terminal apparatus 200 configured as described above, the imager 205 images the two-dimensional code displayed on the window of the image processing apparatus 100. The controller 206 acquires the error text describing the information related to the content of the error having occurred in the image processing apparatus 100 in a natural language, based on the two-dimensional code imaged by the imager 205 without acquiring the text via the Internet, and cause the display 203 to display thereon the error information including the acquired text. In the present embodiment, the controller 206 acquires the error text by decoding the error text from the two-dimensional code imaged by the imager 205.

### (2.4) Operation Example of System

As described above, in the present embodiment, when an error occurs in the image processing apparatus 100, the display 101 of the image processing apparatus 100 does not display thereon a two-dimensional code obtained by encoding a URL for accessing a web site provided by a server, but displays, on the display 101 of the image processing apparatus 100, a two-dimensional code obtained by encoding an error text describing information related to content of the error in a natural language. As the two-dimensional code, a QR code (trade name) is used.

Accordingly, even when the terminal apparatus 200 does not have an Internet connection and/or a server failure occurs, the terminal apparatus 200 does not need to access the web server, and can directly acquire the error text by imaging the two-dimensional code displayed by the image processing apparatus 100 to display the error text. Thus, the user convenience can be further improved.

(2.4.1) Operation Example when Error Occurs

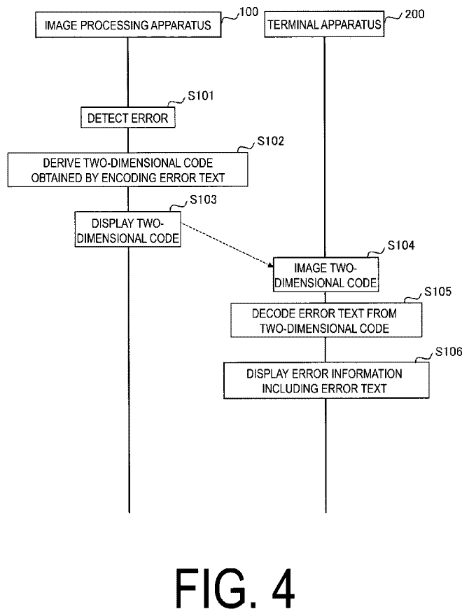

FIG. 4 is a diagram illustrating an operation example when an error occurs in the image processing system according to the present embodiment.

In step S101, the controller 105 of the image processing apparatus 100 detects an error having occurred in the image processing apparatus 100.

In step S102, the controller 105 of the image processing apparatus 100 derives an error text corresponding to content of the error detected in step S101. For example, when the storage 106 stores in advance the error text for each error, the controller 105 acquires the error text corresponding to the content of the error detected in step S101 from the storage 106 and encodes the acquired error text to derive a two-dimensional code. Alternatively, when the storage 106 stores in advance the two-dimensional code for each error, the controller 105 acquires the two-dimensional code corresponding to the content of the error detected in step S101 from the storage 106 to derive the two-dimensional code.

In step S103, the controller 105 of the image processing apparatus 100 causes the display 101 to display thereon the two-dimensional code derived in step S102.

Note that the image processing apparatus 100 may include a physical button or a soft button for displaying the two-dimensional code. When an error occurs in the image processing apparatus 100, the controller 105 of the image processing apparatus 100 may notify the occurrence of the error by blinking the button or blinking a LED. When the user operates the button in such a state, the controller 105 of the image processing apparatus 100 may cause the display 101 to display thereon the two-dimensional code obtained by encoding the error text related to the error (steps S102 and S103).

On the other hand, in step S104, the imager 205 of the terminal apparatus 200 images the two-dimensional code displayed on the display 101 of the image processing apparatus 100 to generate image data.

In step S105, the controller 206 of the terminal apparatus 200 detects the two-dimensional code in the image data generated in step S104, and decodes the error text from the detected two-dimensional code for acquiring the error text.

In step S106, the controller 206 of the terminal apparatus 200 causes the display 203 to display thereon the error text acquired in step S105.

This allows the user operating the terminal apparatus 200 to understand the content of the error having occurred in the image processing apparatus 100 and/or the countermeasure method against the error based on the error text displayed on the display 203 of the terminal apparatus 200.

(2.4.2) Operation Example when Error is Resolved

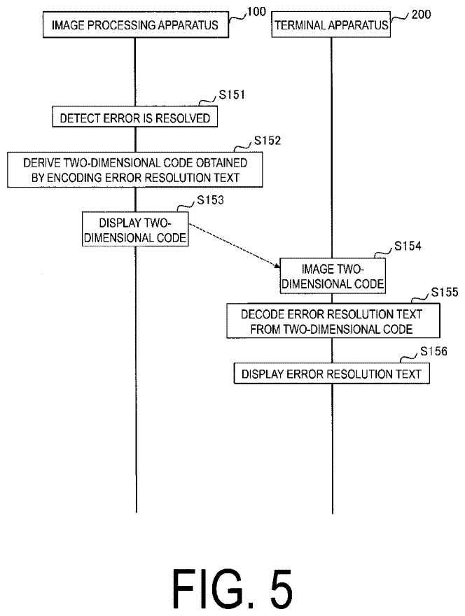

FIG. 5 is a diagram illustrating an operation example when an error is resolved in the image processing system according to the present embodiment.

In step S151, the controller 105 of the image processing apparatus 100 detects the error having occurred in the image processing apparatus 100 is resolved.

In step S152, the controller 105 of the image processing apparatus 100 derives an error resolution text corresponding to content of the error of which resolution is detected in step S151. For example, when the storage 106 stores in advance the error resolution text for each error, the controller 105 acquires the error resolution text corresponding to the content of the error of which resolution is detected in step S151 from the storage 106 and encodes the acquired error resolution text to derive a two-dimensional code. Alternatively, when the storage 106 stores in advance the two-dimensional code for each error, the controller 105 acquires the two-dimensional code corresponding to the content of the error of which resolution is detected in step S151 from the storage 106 for deriving the two-dimensional code.

In step S153, the controller 105 of the image processing apparatus 100 causes the display 101 to display thereon the two-dimensional code derived in step S152.

Note that the image processing apparatus 100 may include a physical button or a soft button for displaying the two-dimensional code. When the error detected in step S101 of FIG. 4 is resolved, the controller 105 of the image processing apparatus 100 may notify the resolution of the error by blinking the button or blinking a LED. When the user operates the button in such a state, the controller 105 of the image processing apparatus 100 may cause the display 101 to display thereon the two-dimensional code obtained by encoding the error resolution text related to the resolution of the error (steps S152 and S153).

On the other hand, in step S154, the imager 205 of the terminal apparatus 200 images the two-dimensional code displayed on the display 101 of the image processing apparatus 100 to generate image data.

In step S155, the controller 206 of the terminal apparatus 200 detects the two-dimensional code in the image data generated in step S154, and decodes the error resolution text from the detected two-dimensional code for acquiring the error resolution text.

In step S156, the controller 206 of the terminal apparatus 200 causes the display 203 to display thereon the error resolution text acquired in step S155.

This allows the user operating the terminal apparatus 200 to grasp what kind of error is resolved in the image processing apparatus 100 based on the error resolution text displayed on the display 203 of the terminal apparatus 200. For example, when a plurality of errors simultaneously occur in the image processing apparatus 100, the error resolved is notified using the error resolution text to allow the user to grasp which error among the plurality of errors is resolved.

### (3) Second Embodiment

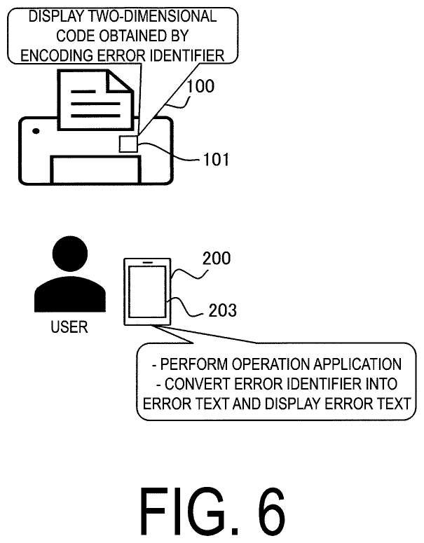

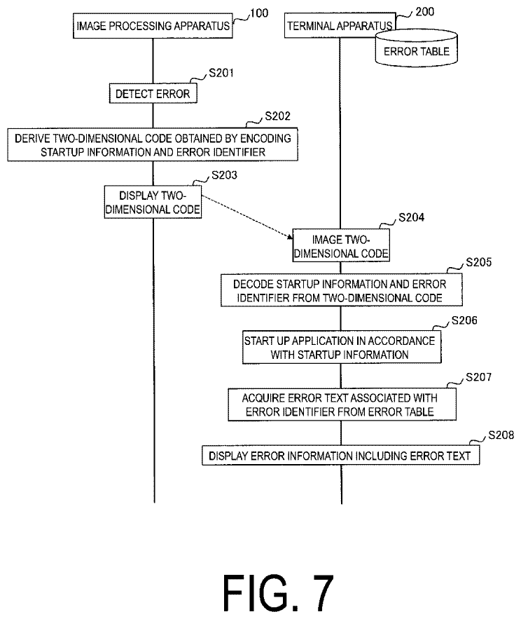

A second embodiment is described with reference to FIGS. 6 and 7, mainly on differences from the first embodiment. Note that in each of the following embodiments, the operations when an error is resolved may be the same as and/or similar to those in the first embodiment described above.

FIG. 6 is a diagram illustrating an outline of an operation of the image processing system according to the present embodiment.

As an amount of information (specifically, the number of characters) to be encoded into the two-dimensional code increases, a size of the two-dimensional code increases. Therefore, when an error text having an excessive number of characters is encoded into a two-dimensional code, there is a concern that the size of the two-dimensional code exceeds a size of the window of the image processing apparatus 100. In the present embodiment, the image processing apparatus 100 displays a two-dimensional code obtained by encoding an error identifier (also referred to as an “error code”) associated with the error text.

The terminal apparatus 200 images the two-dimensional code to acquire the error identifier, converts the error identifier into an error text, and displays the error text. Such conversion and display are performed by an application (for example, an operation application) installed in the terminal apparatus 200. In the following description of the embodiment, an example in which the operation application is used is described, but an application dedicated to displaying an error may be used. For example, the operation application holds a table (also referred to as an “error table”) in which an error identifier is associated with an error text. That is, the terminal apparatus 200 holds the error table in which each of a plurality of predetermined error identifiers is associated with an error text. The terminal apparatus 200 converts the error identifier into an error text by using the error table.

In the present embodiment, the image processing apparatus 100 may display a two-dimensional code in which startup information for starting up the operation application is further encoded. That is, in the two-dimensional code, the startup information may be encoded in addition to the error identifier. This can cause the terminal apparatus 200 to start up the operation application using the startup information.

FIG. 7 is a diagram illustrating an operation example when an error occurs in the image processing system according to the present embodiment. Here, a redundant description of operations same as, and/or similar to, those in the first embodiment described above is omitted.

In step S201, the controller 105 of the image processing apparatus 100 detects an error having occurred in the image processing apparatus 100.

In step S202, the controller 105 of the image processing apparatus 100 derives a two-dimensional code obtained by encoding an error identifier corresponding to content of the error detected in step S201 and the startup information. For example, when the storage 106 stores in advance the error identifier for each error, the controller 105 acquires the error identifier corresponding to the content of the error detected in step S201 from the storage 106 and encodes together the acquired error identifier and the startup information to derive a two-dimensional code. Alternatively, when the storage 106 stores in advance the two-dimensional code in which the error identifier for each error and the startup information are together encoded, the controller 105 acquires the two-dimensional code corresponding to the content of the error detected in step S201 from the storage 106 for deriving the two-dimensional code.

In step S203, the controller 105 of the image processing apparatus 100 causes the display 101 to display thereon the two-dimensional code derived in step S202.

Note that the image processing apparatus 100 may include a physical button or a soft button for displaying the two-dimensional code. When an error occurs in the image processing apparatus 100, the controller 105 of the image processing apparatus 100 may notify the occurrence of the error by blinking the button or blinking a LED. When the user operates the button in such a state, the controller 105 of the image processing apparatus 100 may cause the display 101 to display thereon the two-dimensional code obtained by encoding the error identifier related to the error (steps S202 and S203).

On the other hand, in step S204, the imager 205 of the terminal apparatus 200 images the two-dimensional code displayed on the display 101 of the image processing apparatus 100 to generate image data.

In step S205, the controller 206 of the terminal apparatus 200 detects the two-dimensional code in the image data generated in step S204, and decodes the error identifier and the startup information from the detected two-dimensional code for acquiring the startup information and the error text.

In step S206, the controller 206 of the terminal apparatus 200 starts up the operation application in accordance with the startup information acquired in step S205, and causes the display 203 to display thereon an error display screen.

In step S207, the controller 206 of the terminal apparatus 200 converts the error identifier acquired in step S205 into an error text using the error table for acquiring the error text.

In step S208, the controller 206 of the terminal apparatus 200 causes the display 203 to display thereon the error text acquired in step S207. Here, the controller 206 of the terminal apparatus 200 causes the display 203 to display the error text on the error display screen displayed by the operation application.

In the present embodiment, the operation application (error table) may hold image data associated with at least one error identifier among the plurality of error identifiers. The image data may be data of an image of the image processing apparatus 100 on which a mark indicating an error occurrence location is superimposed. The image data may be data of a guidance image representing a countermeasure method against the error. In step S207, the terminal apparatus 200 (operation application) may further acquire image data associated with the error identifier obtained by the decode. In step S208, the terminal apparatus 200 (operation application) may cause the display 203 to display thereon the error information further including an image based on the acquired image data.

Note that the operation according to the first embodiment and the operation according to the second embodiment may be switchable. For example, when the size (the number of characters) of the error text is equal to or less than a predetermined number, the image processing apparatus 100 may select the operation according to the first embodiment to display the two-dimensional code obtained by encoding the error text. On the other hand, when the size (the number of characters) of the error text exceeds the predetermined number, the image processing apparatus 100 may select the operation according to the second embodiment to display the two-dimensional code obtained by encoding the error identifier and the startup information.

### (4) Third Embodiment

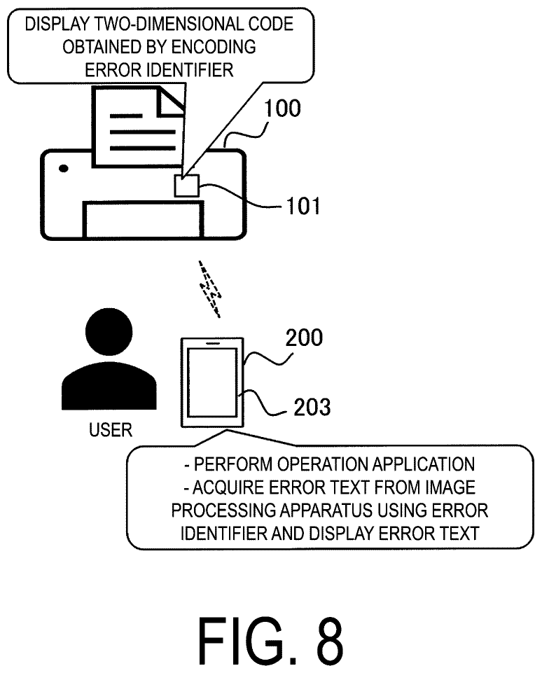

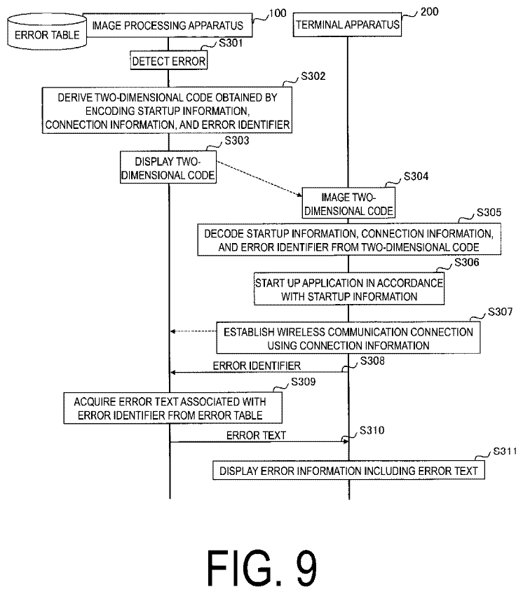

A third embodiment is described with reference to FIGS. 8 and 9, mainly on differences from the first and second embodiments.

FIG. 8 is a diagram illustrating an outline of an operation of the image processing system according to the present embodiment.

In the present embodiment, the error text is transmitted from the image processing apparatus 100 to the terminal apparatus 200 using wireless communication between the image processing apparatus 100 and the terminal apparatus 200. Specifically, the image processing apparatus 100 includes the wireless LAN communicator 103, and the terminal apparatus 200 includes the wireless LAN communicator 201 that establishes a wireless communication connection with the wireless LAN communicator 103.

The image processing apparatus 100 displays the two-dimensional code obtained by encoding the error identifier. The terminal apparatus 200 decodes the error identifier from the imaged two-dimensional code. The terminal apparatus 200 acquires the error text associated with the decoded error identifier from the image processing apparatus 100 via the wireless communication connection using the operation application. Then, the terminal apparatus 200 displays error information including the acquired error text on the operation application.

In the present embodiment, the image processing apparatus 100 may display a two-dimensional code in which connection information used to establish the wireless communication connection is further encoded in addition to the startup information for starting up the operation application. That is, in the two-dimensional code, the startup information and the connection information may be encoded in addition to the error identifier. This allows the terminal apparatus 200 to establish a wireless communication connection with the image processing apparatus 100 using the connection information. The connection information may include an identifier and a password of the image processing apparatus 100 (wireless LAN communicator 103). The identifier may be a service set identifier (SSID).

FIG. 9 is a diagram illustrating an operation example when an error occurs in the image processing system according to the present embodiment. Here, a redundant description of operations same as, and/or similar to, those in the first and second embodiments described above is omitted. In the present embodiment, the image processing apparatus 100 holds an error table as described in the second embodiment.

In step S301, the controller 105 of the image processing apparatus 100 detects an error having occurred in the image processing apparatus 100.

In step S302, the controller 105 of the image processing apparatus 100 derives a two-dimensional code obtained by encoding an error identifier corresponding to content of the error detected in step S301, the startup information, and the connection information. For example, when the storage 106 stores in advance the error identifier for each error, the controller 105 acquires the error identifier corresponding to the content of the error detected in step S301 from the storage 106 and encodes together the acquired error identifier, the startup information, and the connection information to derive a two-dimensional code. Alternatively, when the storage 106 stores in advance the two-dimensional code in which the error identifier for each error, the startup information, and the connection information are together encoded, the controller 105 acquires the two-dimensional code corresponding to the content of the error detected in step S301 from the storage 106 for deriving the two-dimensional code.

In step S303, the controller 105 of the image processing apparatus 100 causes the display 101 to display thereon the two-dimensional code derived in step S302.

Note that the image processing apparatus 100 may include a physical button or a soft button for displaying the two-dimensional code. When an error occurs in the image processing apparatus 100, the controller 105 of the image processing apparatus 100 may notify the occurrence of the error by blinking the button or blinking a LED. When the user operates the button in such a state, the controller 105 of the image processing apparatus 100 may cause the display 101 to display thereon the two-dimensional code obtained by encoding the error identifier related to the error (steps S302 and S303).

On the other hand, in step S304, the imager 205 of the terminal apparatus 200 images the two-dimensional code displayed on the display 101 of the image processing apparatus 100 to generate image data.

In step S305, the controller 206 of the terminal apparatus 200 detects the two-dimensional code in the image data generated in step S304, and decodes the startup information, the connection information, and the error identifier from the detected two-dimensional code to acquire the startup information, the connection information, and the error identifier.

In step S306, the controller 206 of the terminal apparatus 200 starts up the operation application in accordance with the startup information acquired in step S305, and causes the display 203 to display thereon an error display screen.

In step S307, the controller 206 of the terminal apparatus 200 causes the wireless LAN communicator 201 to establish a wireless communication connection with the image processing apparatus 100 based on the connection information (for example, the SSID and the password) acquired in step S305.

In step S308, the controller 206 of the terminal apparatus 200 controls the wireless LAN communicator 201 to transmit, to the image processing apparatus 100, the error identifier acquired in step S305 using the wireless communication connection established in step S307. The wireless LAN communicator 103 of the image processing apparatus 100 receives the error identifier from the terminal apparatus 200.

In step S309, the controller 105 of the image processing apparatus 100 converts the error identifier received in step S308 into an error text using the error table to acquire the error text. That is, the controller 105 of the image processing apparatus 100 acquires the error text, from the error table, associated with the error identifier received by the wireless LAN communicator 103.

In step S310, the controller 105 of the image processing apparatus 100 controls the wireless LAN communicator 103 to transmit the error text acquired in step S309 to the terminal apparatus 200. The wireless LAN communicator 103 of the terminal apparatus 200 receives the error text from the image processing apparatus 100 to acquire the error text.

In step S311, the controller 206 of the terminal apparatus 200 causes the display 203 to display thereon the error text acquired in step S310. Here, the controller 206 of the terminal apparatus 200 causes the display 203 to display the error text on the error display screen displayed by the operation application.

In the present embodiment, the error table of the image processing apparatus 100 may hold image data associated with at least one error identifier among the plurality of error identifiers. The image data may be data of an image of the image processing apparatus 100 on which a mark indicating an error occurrence location is superimposed. The image data may be data of a guidance image representing a countermeasure method against the error. In step S309, the image processing apparatus 100 may further acquire image data associated with the received error identifier. In step S310, the image processing apparatus 100 may further transmit the image data to the terminal apparatus 200. In step S311, the terminal apparatus 200 (operation application) may cause the display 203 to display thereon the error information further including an image based on the image data.

Note that the operation according to the first embodiment and the operation according to the third embodiment may be switchable. For example, when the size (the number of characters) of the error text is equal to or less than a predetermined number, the image processing apparatus 100 may select the operation according to the first embodiment to display the two-dimensional code obtained by encoding the error text. On the other hand, when the size (the number of characters) of the error text exceeds the predetermined number, the image processing apparatus 100 may select the operation according to the third embodiment to display the two-dimensional code obtained by encoding the error identifier and the startup information.

### (5) Fourth Embodiment

A fourth embodiment is described mainly on differences from the first to third embodiments.

In the present embodiment, the image processing apparatus 100 (the controller 105) selects one of a first mode for causing the display 101 to display thereon a first code being a two-dimensional code or a second mode for causing the display 101 to display thereon a second code, the first code being obtained by encoding the error text and/or the error identifier, the second code being obtained by encoding a URL indicating a resource on the Internet that provides the error information. That is, in the present embodiment, the operation (first mode) as in the first to third embodiments and the known operation (second mode) as in Patent Documents 1 and 2 can be switchable.

For example, when the terminal apparatus 200 can access a web server on the Internet that provides error information, the image processing apparatus 100 may preferably select the second mode in order that a large amount of latest error information held by the web server is available. On the other hand, the image processing apparatus 100 preferably selects the first mode when the terminal apparatus 200 cannot access the web server on the Internet that provides the error information. Therefore, the image processing apparatus 100 that detects the error selects one of the first mode or the second mode based on the user operation.

In the present embodiment, the operation inputter 102 of the image processing apparatus 100 includes a button (a physical button or a software button) for receiving a user operation designating the first mode. The controller 105 of the image processing apparatus 100 may select the first mode based on the button receiving a predetermined operation designating the first mode, and select the second mode based on the button not receiving the predetermined operation.

The operation inputter 102 of the image processing apparatus 100 may include a button (a physical button or a software button) for receiving a user operation designating the second mode. The controller 105 of the image processing apparatus 100 may select the second mode based on the button receiving an operation designating the second mode, and select the first mode based on the button not receiving the operation.

Alternatively, the image processing apparatus 100 may select one of the first mode or the second mode based on wireless communication with the terminal apparatus 200. For example, the controller 105 of the image processing apparatus 100 may select the first mode based on the wireless LAN communicator 103 receiving a predetermined signal designating the first mode from the terminal apparatus 200, and may select the second mode based on the wireless LAN communicator 103 not receiving the predetermined signal from the terminal apparatus 200.

Here, the controller 206 of the terminal apparatus 200 may determine whether the resource (web server) on the Internet that provides the error information is available, and control the wireless LAN communicator 201 to transmit the predetermined signal to the image processing apparatus (100) in response to determining that the resource is unavailable. For example, the controller 206 of the terminal apparatus 200 monitors the public network communicator 202 to determine whether to be able to access the web server via the Internet. When the web server can be accessed via the Internet, the controller 206 of the terminal apparatus 200 may control the wireless LAN communicator 103 to transmit a signal designating the second mode to the image processing apparatus 100. On the other hand, when the web server cannot be accessed via the Internet, the controller 206 of the terminal apparatus 200 may control the wireless LAN communicator 103 to transmit a signal designating the first mode to the image processing apparatus 100.

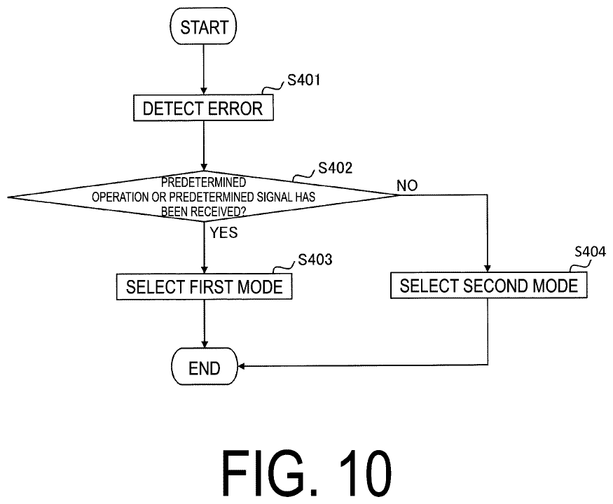

FIG. 10 is a diagram illustrating a operation example of the image processing apparatus 100 according to the present embodiment.

In step S401, the controller 105 of the image processing apparatus 100 detects an error having occurred in the image processing apparatus 100.

In step S402, the controller 105 of the image processing apparatus 100 may determine whether or not the operation inputter 102 receives an operation designating the first mode. The controller 105 of the image processing apparatus 100 may determine whether or not the wireless LAN communicator 103 receives a signal designating the first mode.

For YES in step S402, the controller 105 of the image processing apparatus 100 selects the first mode in step S403. That is, the controller 105 of the image processing apparatus 100 causes the display 101 to display thereon the first code that is a two-dimensional code obtained by encoding the error text and/or the error identifier.

On the other hand, for NO in step S402, the controller 105 of the image processing apparatus 100 selects the second mode in step S404. That is, the controller 105 of the image processing apparatus 100 causes the display 101 to display thereon the second code obtained by encoding the URL indicating the resource on the Internet that provides the error information.

### (6) Other Embodiments

In the above-described embodiments, “printing” may include 3D printing. That is, the image processing apparatus 100 may have a function of 3D printing. For example, the printer 104a may be a 3D printer that forms a three-dimensional object using resins and/or metallic powders.

The operational flow of each of the embodiments described above need necessarily be executed in chronological order according to the order described in the flow diagram. For example, the steps of operation may be performed in a different order from that described in the flow diagram or may be performed in parallel. Some steps of operation may be omitted and additional steps may be added to the process.

A program that causes the computer (the image processing apparatus 100, the terminal apparatus 200) to perform operations according to the embodiments described above may be provided. The program may be recorded in a computer readable medium. Use of the computer readable medium enables the program to be installed on a computer (an information processing apparatus). Here, the computer readable medium on which the program is recorded may be a non-transitory recording medium. The non-transitory recording medium is not particularly limited, and may be, for example, a recording medium such as a CD-ROM or a DVD-ROM.

The phrases “based on” and “depending on/in response to” used in the present disclosure do not mean “based only on” and “only depending on/in response to,” unless specifically stated otherwise. The phrase “based on” means both “based only on” and “based at least in part on”. Similarly, the phrase “depending on” means both “only depending on” and “at least partially depending on”. The terms “include”, “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (7) Supplements

Features relating to the embodiments described above are described below as supplements.

### (Supplementary Note 1)

An image processing system including:
a terminal apparatus (200); and
an image processing apparatus (100) configured to perform image processing including printing
and/or scanning, wherein
the image processing apparatus (100) includes:
a first display (101) including a window configured to display a code; and
a first controller (105) configured to cause the first display (101) to display, based on occurrence of an error in the image processing apparatus (100), the code obtained by encoding text describing information related to content of the error in a natural language and/or an error identifier associated with the text,
the terminal apparatus (200) includes:
a second display (203); and
an imager (205) configured to image the code displayed on the first display (101), and
a second controller (206) configured to acquire the text, based on the code imaged by the imager (205) without acquiring the text via the Internet, and cause the second display (203) to display error information including the acquired text.

### (Supplementary Note 2)

The image processing system described in the supplementary note 1, wherein
the first controller (105) causes the first display (101) to display the code obtained by encoding the text, and
the second controller (206) acquires the text by decoding the text from the code imaged by the imager (205).

### (Supplementary Note 3)

The image processing system described in the supplementary note 1, wherein
the first controller (105) causes the first display (101) to display the code obtained by encoding the error identifier, and
the second controller (206)
decodes the error identifier from the code imaged by the imager (205),
acquires the text associated with the decoded error identifier using an application for displaying the error information, and
causes the second display (203) to display the error information including the acquired text on the application.

### (Supplementary Note 4)

The image processing system described in the supplementary note 3, wherein
the first controller (105) causes the first display (101) to display the code in which startup information for starting up the application is further encoded, and
the second controller (206)
further decodes the startup information from the code imaged by the imager (205), and starts up the application in accordance with the decoded startup information.

### (Supplementary Note 5)

The image processing system described in the supplementary note 4, wherein
the application holds a table in which each of a plurality of predetermined error identifiers is associated with the text, and
the second controller (206) acquires the text associated with the decoded error identifier, based on the table.

### (Supplementary Note 6)

The image processing system described in the supplementary note 5, wherein
the application holds image data associated with at least one error identifier among the plurality of error identifiers, and
the second controller (206) further acquires the image data associated with the decoded error identifier, and causes the second display (203) to display the error information further including an image based on the acquired image data.

### (Supplementary Note 7)

The image processing system described in the supplementary note 1, wherein
the image processing apparatus (100) further includes a first wireless communicator (103), the terminal apparatus (200) further includes a second wireless communicator (201) configured to establish a wireless communication connection with the first wireless communicator (103), the first controller (105) causes the first display (101) to display the code obtained by encoding the error identifier, and
the second controller (206):
decodes the error identifier from the code imaged by the imager (205);
acquires the text associated with the decoded error identifier from the image processing apparatus (100) via the wireless communication connection, using an application for displaying the error information; and
causes the second display (203) to display the error information including the acquired text on the application.

### (Supplementary Note 8)

The image processing system described in the supplementary note 7, wherein
the second controller (206) controls the second wireless communicator (201) to transmit the decoded error identifier to the image processing apparatus (100),
the first wireless communicator (103) receives the error identifier from the terminal apparatus (200), and
the first controller (105) controls the first wireless communicator (103) to transmit the text associated with the error identifier received by the first wireless communicator (103) to the terminal apparatus (200).

### (Supplementary Note 9)

The image processing system described in the supplementary note 7 or 8, wherein
the first controller (105) causes the first display (101) to display the code in which startup information for starting up the application is further encoded, and
the second controller (206):
further decodes the startup information from the code imaged by the imager (205); and
starts up the application in accordance with the decoded startup information.

### (Supplementary Note 10)

The image processing system described in any one of the supplementary notes 7 to 9, wherein the first controller (105) causes the first display (101) to display the code in which connection information used to establish the wireless communication connection is further encoded, and the second controller (206):
further decodes the connection information from the code imaged by the imager (205); and
causes the second communicator (201) to establish the wireless communication connection based on the connection information.

### (Supplementary Note 11)

The image processing system described in any one of the supplementary notes 1 to 10, wherein the text includes content information indicating content of the error and/or countermeasure information indicating a countermeasure method against the error.

### (Supplementary Note 12)

The image processing system described in any one of the supplementary notes 1 to 11, wherein the first controller (105) causes the first display (101) to display a code obtained by encoding an error resolution text describing information indicating that the error is resolved in a natural language, in response to resolving the error.

### (Supplementary Note 13)

The image processing system described in the supplementary note 12, wherein the second controller (206):
decodes the error resolution text from the code imaged by the imager (205); and
causes the second display (203) to display the decoded error resolution text.

### (Supplementary Note 14)

The image processing system described in any one of the supplementary notes 1 to 13, wherein the code is a two-dimensional code, and
the first display (101) has a substantially square screen shape along an outer peripheral shape of the two-dimensional code.

### (Supplementary Note 15)

The image processing system described in any one of the supplementary notes 1 to 14, wherein the first controller (105) selects one of a first mode in which the first display (101) is caused to display a first code being the code obtained by encoding the text and/or the error identifier, or a second mode in which the first display (101) is caused to display a second code obtained by encoding a Uniform Resource Locator (URL) indicating a resource on the Internet that provides the error information.

### (Supplementary Note 16)

The image processing system described in the supplementary note 15, wherein
the image processing apparatus (100) further includes an operation inputter configured to receive a user operation, and
the first controller (105):
selects the first mode in response to the operation inputter receiving a predetermined operation designating the first mode; and
selects the second mode in response to the operation inputter not receiving the predetermined operation.

### (Supplementary Note 17)

The image processing system described in the supplementary note 15, wherein
the first controller (105)
selects the first mode in response to the image processing apparatus (100) receiving a predetermined signal designating the first mode from the terminal apparatus (200) through wireless communication; and
selects the second mode in response to the image processing apparatus (100) not receiving the predetermined signal from the terminal apparatus (200).

### (Supplementary Note 18)

The image processing system described in the supplementary note 17, wherein
the second controller (206):
determines whether the resource on the Internet is available; and
performs control to transmit the predetermined signal to the image processing apparatus (100) when determining that the resource is unavailable.

### (Supplementary Note 19)

An image processing apparatus (100) for performing image processing including printing and/or scanning, the image processing apparatus (100) including
a display (101) including a window configured to display a code, and
a controller (105) configured to cause the display (101) to display, based on occurrence of an error in the image processing apparatus (100), the code obtained by encoding text describing information related to content of the error in a natural language and/or an error identifier associated with the text.

### (Supplementary Note 20)

A terminal apparatus (200) including
a display (203),
an imager (205) configured to image a code displayed on a window in an image processing apparatus (100) configured to perform image processing including printing and/or scanning, and
a controller (206) configured to acquire text describing information related to content of an error having occurred in the image processing apparatus (100) in a natural language, based on the imaged code without acquiring the text via the Internet, and cause the display (203) to display error information including the acquired text.

### (Supplementary Note 21)

A program causing a terminal apparatus (200) including an imager (205) and a display (203) to execute the steps of:
imaging a code displayed on a window in an image processing apparatus (100) configured to perform image processing including printing and/or scanning;
acquiring text describing information related to content of an error having occurred in the image processing apparatus (100) in a natural language, based on the imaged code without acquiring the text via the Internet; and
causing the display (203) to display error information including the acquired text.

### REFERENCE SIGNS

100: Image processing apparatus
101: Display
102: Operation inputter
103: Wireless LAN communicator
104: Image processor
104a: Printer
104b: Scanner
104c: Public network communicator
105: Controller
106: Storage

1. An image processing system comprising:
a terminal apparatus; and
an image processing apparatus configured to perform image processing comprising printing and/or scanning,
wherein the image processing apparatus comprises:
a first display comprising a window configured to display a code; and
a first controller configured to cause the first display to display, based on occurrence of an error in the image processing apparatus, the code obtained by encoding text describing information related to content of the error in a natural language and/or an error identifier associated with the text, and
the terminal apparatus comprises:
a second display; and
an imager configured to image the code displayed on the first display, and
a second controller configured to acquire the text, based on the code imaged by the imager without acquiring the text via the Internet, and cause the second display to display error information comprising the acquired text.

2. The image processing system according to claim 1, wherein
the first controller causes the first display to display the code obtained by encoding the text, and
the second controller acquires the text by decoding the text from the code imaged by the imager.

3. The image processing system according to claim 1, wherein
the first controller causes the first display to display the code obtained by encoding the error identifier, and
the second controller:
decodes the error identifier from the code imaged by the imager;
acquires the text associated with the decoded error identifier using an application for displaying the error information; and
causes the second display to display the error information comprising the acquired text on the application.

4. The image processing system according to claim 3, wherein
the first controller causes the first display to display the code in which startup information for starting up the application is further encoded, and
the second controller:
further decodes the startup information from the code imaged by the imager; and
starts up the application in accordance with the decoded startup information.

5. The image processing system according to claim 4, wherein
the application holds a table in which each of a plurality of predetermined error identifiers is associated with the text, and
the second controller acquires the text associated with the decoded error identifier, based on the table.

6. The image processing system according to claim 5, wherein
the application holds image data associated with at least one error identifier among the plurality of error identifiers, and
the second controller further acquires the image data associated with the decoded error identifier, and causes the second display to display the error information further comprising an image based on the acquired image data.

7. The image processing system according to claim 1, wherein
the image processing apparatus further comprises a first wireless communicator,
the terminal apparatus further comprises a second wireless communicator configured to establish a wireless communication connection with the first wireless communicator,
the first controller causes the first display to display the code obtained by encoding the error identifier, and
the second controller:
decodes the error identifier from the code imaged by the imager;
acquires the text associated with the decoded error identifier from the image processing apparatus via the wireless communication connection, using an application for displaying the error information; and
causes the second display to display the error information comprising the acquired text on the application.

8. The image processing system according to claim 7, wherein
the second controller controls the second wireless communicator to transmit the decoded error identifier to the image processing apparatus,
the first wireless communicator receives the error identifier from the terminal apparatus, and
the first controller controls the first wireless communicator to transmit the text associated with the error identifier received by the first wireless communicator to the terminal apparatus.

9. The image processing system according to claim 7, wherein
the first controller causes the first display to display the code in which startup information for starting up the application is further encoded, and
the second controller:
further decodes the startup information from the code imaged by the imager; and
starts up the application in accordance with the decoded startup information.

10. The image processing system according to claim 7, wherein
the first controller causes the first display to display the code in which connection information used to establish the wireless communication connection is further encoded, and
the second controller:
further decodes the connection information from the code imaged by the imager; and
causes the second communicator to establish the wireless communication connection based on the connection information.

11. The image processing system according to claim 1, wherein
the text comprises content information indicating content of the error and/or countermeasure information indicating a countermeasure method against the error.

12. The image processing system according to claim 1, wherein
the first controller causes the first display to display a code obtained by encoding an error resolution text describing information indicating that the error is resolved in a natural language, in response to resolving the error.

13. The image processing system according to claim 12, wherein
the second controller:
decodes the error resolution text from the code imaged by the imager; and
causes the second display to display the decoded error resolution text.

14. The image processing system according to claim 1, wherein
the code is a two-dimensional code, and
the first display has a substantially square screen shape along an outer peripheral shape of the two-dimensional code.

15. The image processing system according to claim 1, wherein
the first controller selects one of a first mode in which the first display is caused to display a first code being the code obtained by encoding the text and/or the error identifier, or a second mode in which the first display is caused to display a second code obtained by encoding a Uniform Resource Locator (URL) indicating a resource on the Internet that provides the error information.

16. The image processing system according to claim 15, wherein
the image processing apparatus further comprises an operation inputter configured to receive a user operation, and
the first controller:
selects the first mode in response to the operation inputter receiving a predetermined operation designating the first mode; and
selects the second mode in response to the operation inputter not receiving the predetermined operation.

17. The image processing system according to claim 15, wherein
the first controller:
selects the first mode in response to the image processing apparatus receiving a predetermined signal designating the first mode from the terminal apparatus through wireless communication; and
selects the second mode in response to the image processing apparatus not receiving the predetermined signal from the terminal apparatus.

18. The image processing system according to claim 17, wherein
the second controller:
determines whether the resource on the Internet is available; and
performs control to transmit the predetermined signal to the image processing apparatus when determining that the resource is unavailable.

19. An image processing apparatus for performing image processing comprising printing and/or scanning, the image processing apparatus comprising:
a display comprising a window configured to display a code; and
a controller configured to cause the display to display, based on occurrence of an error in the image processing apparatus, the code obtained by encoding text describing information related to content of the error in a natural language and/or an error identifier associated with the text.

20. A terminal apparatus comprising:
a display;
an imager configured to image a code displayed on a window in an image processing apparatus configured to perform image processing comprising printing and/or scanning; and
a controller configured to acquire text describing information related to content of an error having occurred in the image processing apparatus in a natural language, based on the imaged code without acquiring the text via the Internet, and cause the display to display error information comprising the acquired text.
